(19) United States
(12) Patent Application Publication
(10) Pub. No.: US 2012/0062374 A1
(43) Pub. Date: Mar. 15, 2012

(54) COMMUNICATION SYSTEMS INTEROPERATING WITH INTEGRATED TERMINAL AND METHOD FOR ACQUIRING INFORMATION THROUGH INTEROPERATING COMMUNICATION SYSTEMS

(75) Inventors: Hyungu HWANG, Daejeon (KR); JungSook BAE, Daejeon (KR)

(73) Assignee: Electronics and Telecommunications Research Institute, Daejeon (KR)

(21) Appl. No.: 13/231,291

(22) Filed: Sep. 13, 2011

(30) Foreign Application Priority Data
Sep. 13, 2010 (KR) 10-2010-0089617

(51) Int. Cl. B60Q 1/00; G06F 15/16; G08G 1/00

(52) U.S. Cl. 340/438; 701/118; 709/217

(57) ABSTRACT

Provided is a method for providing information to a mobile object or acquiring information from a mobile object. The method for providing information to a mobile object includes providing information obtained by an information acquisition system to an interoperable communication system and providing information outputted from the communication system to the mobile object.

### CROSS-REFERENCE TO RELATED APPLICATIONS

This U.S. non-provisional patent application claims priority under 35 U.S.C. §119 to Korean Patent Application No. 10-2010-0089617, filed on Sep. 13, 2010, the entire contents of which are hereby incorporated by reference.

### BACKGROUND OF THE INVENTION

The present invention disclosed herein relates to a communication system, and more particularly, to communication systems interoperating with an integrated terminal and a method for acquiring information through interoperations between communication systems.

Various types of communication systems have been developed with advancements of information and communication technology. However, the communication systems are operated independently without interoperations between them. For instance, a communication system such as a navigation device performs an operation for finding its location using information of a GPS receiver, and a communication system such as a cell phone just performs wireless communication with a base station. That is, the two communication systems are operated independently without interoperations between them.

However, in the case that such an integrated terminal illustrated in FIG. 1 is implemented as one of communication systems, interoperations with other communication systems, e.g., a vehicle system, an Intelligent Transport System (ITS), or a mobile communication system, may be needed for more efficiently providing an information service.

### SUMMARY OF THE INVENTION

The present invention provides an improved method for providing supplementary information obtained from an arbitrary communication system to an interoperated another communication system for extending and maximizing information service.

The present invention also provides a method for obtaining information through interoperations of an integrated terminal and communication systems.

The present invention also provides a configuration of communication systems capable of transferring vehicle information or movement information to an intelligent transport system through an integrated terminal and a mobile communication system and a method for obtaining information through interoperations of communication systems.

The present invention also provides a configuration of communication systems capable of transferring traffic information of an intelligent transport system to a vehicle system through an integrated terminal and a mobile communication system and a method for obtaining information through interoperations of communication systems.

The present invention also provides a configuration of communication systems capable of transferring vehicle information or movement information to an intelligent transport system and transferring traffic information of an intelligent transport system to a vehicle system making a mobile communication system interoperate with the intelligent transport system and an integrated terminal and a method for obtaining information through interoperations of communication systems.

Embodiments of the present invention provide methods for acquiring information from a mobile object, the method including providing information acquired from the mobile object to an integrated terminal; providing needed information among information outputted from the integrated terminal to a communication system; and providing the information outputted from the communication system to an information acquisition system interoperated with the integrated terminal and the communication system.

In some embodiments, the information acquisition system may be an Intelligent Transport System (ITS) in the case that the mobile object is a vehicle.

In other embodiments, the needed information provided to the communication system may include at least one of location information of the vehicle, speed information of the vehicle, velocity information of the vehicle, departure place information, and destination information.

In still other embodiments, the communication system may also transfer location information of the integrated terminal detected by a base station to the ITS when the communication system provides the information to the ITS.

In even other embodiments, information of the vehicle provided through the integrated terminal may include at least one of a vehicle ID with a car number, a kind of the vehicle, accident occurrence information related to a traffic accident or a vehicle breakdown, and air bag deployment information.

In yet other embodiments, the ITS may check whether a speed of a vehicle is rapidly decreased and a vehicle density is rapidly increased when a vehicle approaches a certain point and the speed of a vehicle is increased and the vehicle density is decreased after a vehicle passes the certain point using the location information and velocity information of a vehicle to detect an abrupt traffic jam.

In other embodiments of the present invention, methods for providing information to a mobile object include providing information obtained by an information acquisition system to an interoperable communication system; and providing information outputted from the communication system to the mobile object.

In some embodiments, the mobile object may be an integrated terminal interoperated with the communication system in the case that the information acquisition system is an ITS.

In other embodiments, information of the integrated terminal may be transferred to a vehicle.

In still other embodiments, the vehicle may calculate a standby time under a signal light at a current location using signal lighting information provided from the ITS to save energy of the vehicle.

In still other embodiments of the present invention, methods for providing drive information to a driver include transferring signal lighting information of an ITS to an integrated terminal through a communication system; generating information which indicates whether it is possible to pass a signal light by calculating a current speed of a vehicle and a distance between the vehicle and the signal light based on the signal lighting information; and providing the generated information to the driver.

In still other embodiments of the present invention, interoperation systems include a vehicle system configured to provide vehicle information and drive-related information being installed to a vehicle; an integrated terminal configured to receive information outputted from the vehicle system; a communication system configured to receive needed information among information outputted from the integrated terminal; and an intelligent transport system configured to be interoperated with the integrated terminal and the communication system and receive information outputted from the communication system.

In some embodiments, the information outputted to the communication system may be at least one of location information of the vehicle, speed information of the vehicle, velocity information of the vehicle, departure place information, and destination information.

In other embodiments, the information provided by the vehicle system may include at least one of vehicle ID with a car number, a kind of the vehicle, accident occurrence information related to a traffic accident or a vehicle breakdown, and air bag deployment information.

In still other embodiments, the intelligent transport system may determine a traffic jam state in real time detecting a vehicle density at a crossroad and lengthens a lighting time of traffic lights on a road where the vehicle density is high in the case of controlling traffic lights using the location information and velocity information of each vehicle.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating an integrated terminal applied to the present invention;

FIG. 2 is a block diagram illustrating a whole system interoperating with an integrated terminal according to an embodiment of the present invention; and

FIG. 3 is a block diagram illustrating a whole system interoperating with an integrated terminal according to another embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

In the specification, when it is commented that some devices or lines are connected to a target block, the connection includes not only a direct connection but also an indirect connection through another device.

Also, like reference numerals refer to like elements throughout. In some drawings, connections between devices and lines are illustrated just for efficiently explaining technical contents, and thus, other devices or blocks may be further included.

The embodiments exemplified and described in this disclosure may include their complementary embodiments. It should be noted that typical communication processes between a mobile communication system and a mobile communication terminal are omitted so as not to obscure the present invention.

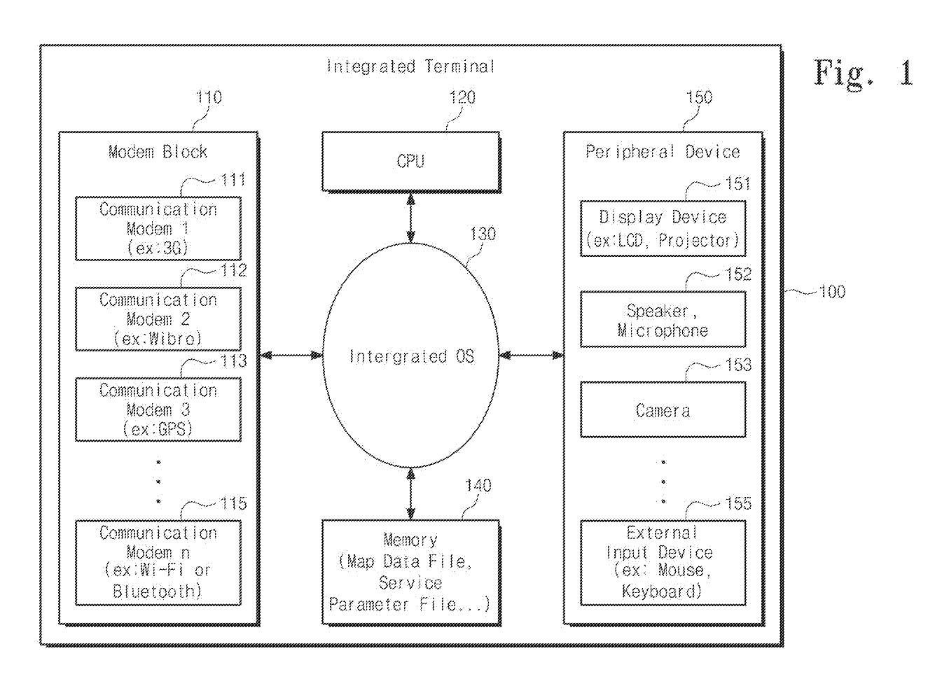

FIG. 1 is a block diagram illustrating an integrated terminal applied to the present invention. Referring to FIG. 1, an integrated terminal 100 includes a modem block 110, a Central Processing Unit (CPU) 120, an integrated Operating System (OS) 130, a memory 140, and a peripheral device 150.

For implementing functions of the integrated terminal, the modem block 110 may include a first communication modem 111 for 3G communication, a second communication modem 112 for WiBro communication, a third communication modem 113 for GPS communication, and nth communication modem 115 for Wi-Fi or Bluetooth communication.

The CPU 120 performs various processes according to various application programs based on the integrated OS 130.

The peripheral device 150 may include a display device 151 such as an LCD or projector, speaker and microphone 152, a camera 153, and an external input device 155 such as a mouse or keyboard.

Since the integrated mobile communication terminal illustrated in FIG. 1 may be substantially implemented considering recent technology trends, it may be called the integrated terminal in the specification.

An interoperation between the integrated terminal and other communication systems makes it more efficient to provide information needed for each system. For instance, in the case that a mobile communication system is interoperated with an Intelligent Transport System (ITS) and the integrated terminal, information of a vehicle or movement may be transferred to the ITS or transport-related information acquired by the ITS may be transferred to a vehicle system which communicates with the integrated terminal.

It will be mainly exemplified that the ITS and the integrated terminal are interoperated through a mobile communication system for describing embodiments of the present invention; however, the present invention is not limited thereto. A basic concept of the present invention may be applied to any case of exchanging needed information between systems. Therefore, the present invention may be applied to all the communicable systems adopting modems.

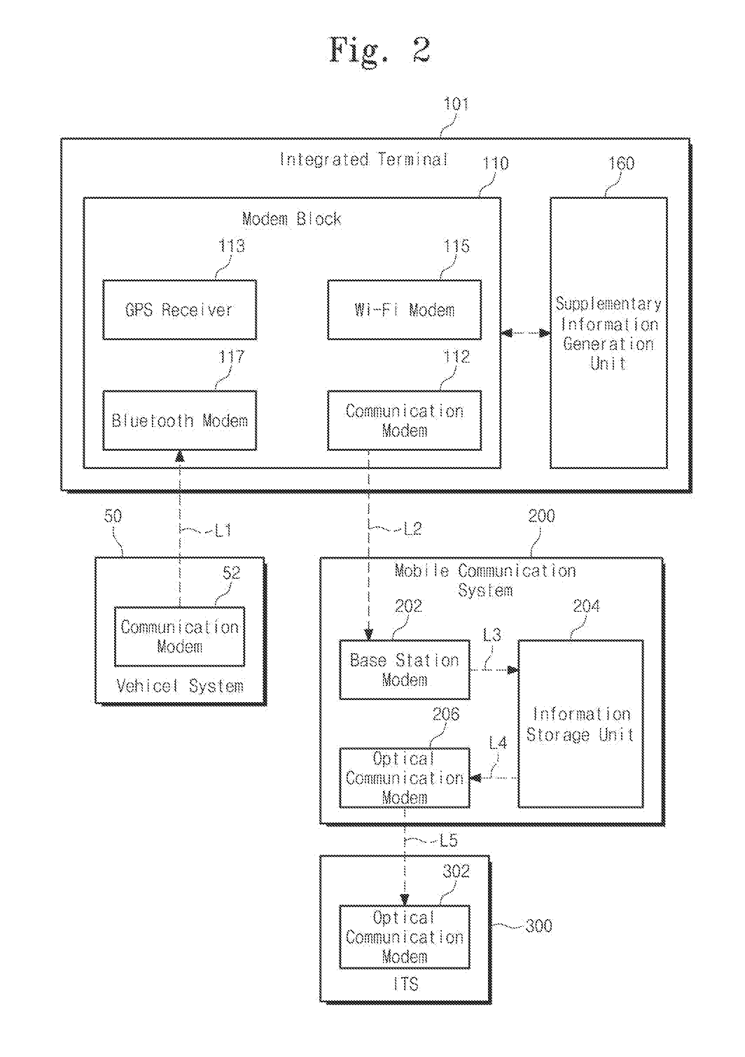

FIG. 2 is a block diagram illustrating a whole system interoperating with an integrated terminal according to an embodiment of the present invention.

Referring to FIG. 2, in the whole system, a mobile communication system 200 is interoperated between an integrated terminal 101 having the above-described structure illustrated in FIG. 1 and an ITS 300, and a vehicle system 50 having a communication modem 52 is connected to a Bluetooth modem 117 of the integrated terminal 101.

The integrated terminal 101 of FIG. 2 includes a supplementary information generation unit 160 connected to a modem block 110. The integrated terminal 101 of FIG. 2 may have substantially the same structure as that of the integrated terminal 100 of FIG. 1 or may have blocks of added or reduced functions.

Therefore, the integrated terminal 101 of FIG. 1 may receive vehicle information through the vehicle system 50 and may also gain various kinds of supplementary information. That is, the supplementary information may include location information obtained through GPS, weather information, map data information, communication system information, and second information reprocessing those kinds of information. Such supplementary information may be directly inputted by a user of the integrated terminal or may be secured by a certain sensor included in the integrated terminal. Also, the supplementary information may be secured through data transfer from another communication network.

Referring to FIG. 2, information of the vehicle system 50 is collected to the integrated terminal 101 and then transferred to the ITS 300 through the mobile communication system. Therefore, the ITS 300 may collect vehicle driving information, appropriately control a traffic signal, or perform various transport-related operations without a traffic density collector such as a CCTV.

Therefore, the system interoperation illustrated in FIG. 2 may eliminate or minimize use of various traffic density collectors or various communication equipment provided to a current ITS. A typical ITS collects traffic information in a busy downtown or highway through the traffic density collector such as the CCTV in real time to efficiently operate a traffic system. However, according to the typical ITS operation, traffic density collectors should be installed on every road. Also, in the case that a bus informs an integrated processor of a bus location, the integrated processor converts the location to an arriving time and transfers the arriving time to a monitor installed to a bus stop. Even in this case, a GPS receiver and a special transmitter should be installed in a bus.

On the contrary, in the interoperation structure illustrated in FIG. 2, the integrated terminal illustrated in FIG. 1 is adopted, the communication modem 52 such as Bluetooth is provided to the vehicle system 50, the modem block 110 is provided to the integrated terminal 101, a base station modem 202 and an optical communication modem 206 are provided to the mobile communication system 200, an optical communication modem 302 is provided to the ITS 300, and communication systems are interoperated with each other. Therefore, use of the traffic density collector of the typical ITS, the GPS receiver, and the special transmitter may be minimized or eliminated.

Information obtained from a moving object such as the vehicle system 50 is provided to the Bluetooth modem 117 of the integrated terminal 101 through a wireless line L1. Since a Bluetooth function is included in a typical integrated terminal, the Bluetooth modem 52 may also be adopted for the vehicle system 50. Therefore, the vehicle system 50 may transfer vehicle information to the integrated terminal 101 through the Bluetooth modem 52. For instance, the vehicle information may include a vehicle ID such as a car number, a kind of a vehicle, accident occurrence information such as a traffic accident or a vehicle breakdown, and air bag deployment information.

A mobile communication modem 112 of the integrated terminal 101 selects information needed for the ITS from various information collected by the integrated terminal 101 and transfers the selected information to the base station modem 202 of the mobile communication system 200 through a wireless line L2. Therefore, in this case, not only the vehicle information provided through the vehicle system 50 but also the information needed for the ITS among the supplementary information acquired by the integrated terminal 101 is transferred through the wireless line L2. The information needed for the ITS among the supplementary information may include at least one of vehicle location information, vehicle speed information, vehicle velocity information, departure place information, and destination information.

The mobile communication modem 112 of the integrated terminal 101 transfers supplementary information including the vehicle information to the base station modem 202 of the mobile communication system 200.

The mobile communication system 200 provides information stored in an information storage unit 204 to the ITS 300 acting as an information acquisition system through a communication line L5. Herein, the communication between the mobile communication system 200 and the ITS 300 may be implemented with a relatively low cost using optical fiber cable. Therefore, the ITS 300 may collect vehicle driving information, appropriately control a traffic signal, or perform various transport-related operations without a traffic density collector.

For more efficiently implementing the embodiment of FIG. 2, consumption of wireless resources is needed to be minimized. To this end, in the case that a user holds the integrated terminal 101 in a vehicle and then gets off the vehicle to move to another place, the integrated terminal 101 is needed to sense this situation and transfer a state of connection or disconnection from the vehicle system 50 to the mobile communication system 200. In this case, the wireless resources are rarely consumed. The mobile communication system 200 determine whether there is information related to a vehicle in an accessing integrated terminal and selects information of the integrated terminal 101 having the vehicle-related information to transfers the selected information to the ITS 300.

Meanwhile, notification of a vehicle location may be performed in two methods as follows.

One method is reporting a location of a base station of a mobile communication system as the vehicle location. According to this method, since the integrated terminal is not needed to periodically report an accurate location of the integrated terminal to the base station, the wireless resources may be saved. However, the location cannot be accurately found.

The other is periodically reporting the accurate location of the integrated terminal. According to this method, the wireless resources are rather consumed. However, since the location may be accurately found, the ITS operation may be very correctly performed. Also, in a next generation mobile communication system, if a location-based service is provided, the location of the integrated terminal may be transferred not for the ITS but for the mobile communication system itself. Therefore, in this case, the application of the present invention may be more efficient.

In the case that the ITS 300 collects information as illustrated in FIG. 2, it is not needed to install an ITS terminal to a vehicle or install the traffic density collector such as the CCTV on a road for the ITS 300. Therefore, without burden of installing equipment for collecting information, the location and velocity information of a vehicle may be simply obtained. Also, using the location and velocity information of a vehicle obtained through the integrated terminal, the ITS 300 may detect a traffic jam or an accident in real time. And, the ITS 300 may efficiently operate a traffic signal system based on the extensive real-time vehicle information.

For instance, the ITS 300 checks whether a speed of a vehicle is rapidly decreased and a vehicle density is rapidly increased when a vehicle approaches a certain point and the speed of a vehicle is increased and the vehicle density is decreased after a vehicle passes the certain point using the location information and velocity information of a vehicle to detect an abrupt traffic jam.

Also, in the case of controlling traffic lights using the location information and velocity information of a vehicle, the ITS 300 may determine a traffic jam state in real time detecting a vehicle density at a crossroad and may lengthen a lighting time of traffic lights on a road where the vehicle density is high.

In this way, the ITS 300 may efficiently perform the traffic control receiving the information of the integrated terminal through the mobile communication system.

The integrated terminal 101 may be a recently well-known smart phone. Various smart phones spotlighted in a recent cell phone market include various functions supporting from MP3 and Internet to virtual reality and social network. For instance, the smart phone may be a smart phone called HD2, Omnia2 (SKT), Layla (KT), or Oz-Omnia (LGT) adopting Windows-based OS, or a smart phone called iPhone, Galaxy S, Galaxy A, Sirius Alpha, Motoglam, X10, MOTO QRTY, Optimus Z, Sirius, Motoroi, Desire, Nexus One, Andro-1, Izar, or Optimus Q adopting Android-based OS.

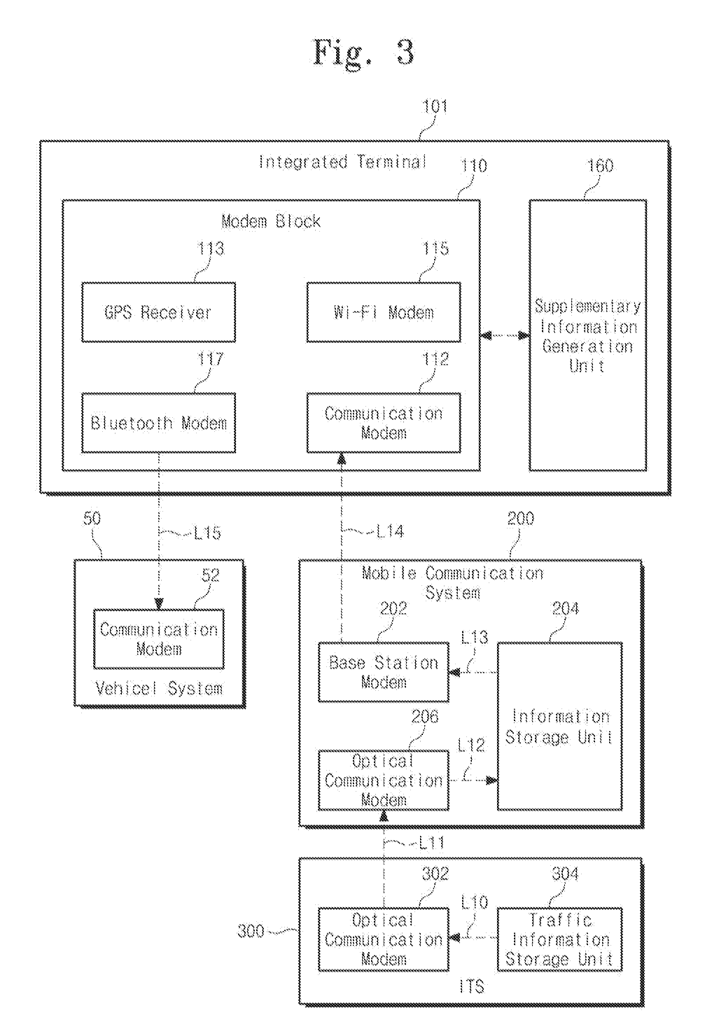

FIG. 3 is a block diagram illustrating a whole system interoperating with an integrated terminal according to another embodiment of the present invention.

Referring to FIG. 3, in the whole system, a mobile communication system 200 is interoperated between an integrated terminal 101 having the above-described structure illustrated in FIG. 1 and an ITS 300, and a vehicle system 50 having a communication modem 52 is connected to a Bluetooth modem 117 of the integrated terminal 101.

The integrated terminal 101 of FIG. 3 includes a supplementary information generation unit 160 connected to a modem block 110. The integrated terminal 101 of FIG. 3 may have substantially the same structure as that of the integrated terminal 100 of FIG. 1 or may have blocks of added or reduced functions.

In the case of FIG. 3, unlike FIG. 2, the lines L11 to L15 are come from the ITS 300 toward the vehicle system 50. As a result, the structure of FIG. 3 is prepared for the vehicle system 50 to acquire the traffic information from the ITS 300. That is, for providing information to the movable vehicle system 50 or the integrated terminal 101, information acquired from an information acquisition system such as the ITS 300 is provided to the interoperable mobile communication system 200 and information outputted from the mobile communication system 200 is provided to the movable object.

The traffic information collected and reprocessed by the ITS 300 may be transferred to the optical communication modem 206 of the mobile communication system 200 through the line L11 which may be configured for optical communication.

The mobile communication system 200 transfers the traffic information of the ITS 300 to the mobile communication modem 112 of the integrated terminal 101 through the wireless line L14. In detail, the traffic information of the ITS 300 is temporarily stored in the information storage unit 204 and is transferred to the mobile communication modem 112 of the integrated terminal 101 via the line L13 and the base station modem 202 when the base station modem 202 is enabled.

The integrated terminal 101 transfers the traffic information to the vehicle system 50 through the wireless line L15 formed between the modems 117 and 52. Accordingly, a vehicle installed with the vehicle system 50 may acquire the traffic information.

Also, the integrated terminal may not transfer the traffic information to the communication modem 52 of the vehicle system 50 and may directly process the traffic information to inform a user. For instance, in the case that the integrated terminal 101 includes an application which has a navigation function, the integrated terminal 101 may use the traffic information for itself.

According to the structure illustrated in FIG. 3, the traffic information generated by the ITS 300 may be provided to the integrated terminal 101 through a communication network of the mobile communication system 200. Therefore, a vehicle or the integrated terminal 101 may acquire the traffic information in real time.

In the case that the information of what road is jammed and where an abrupt jam occurs is provided to a vehicle or the integrated terminal 101 in real time, the vehicle system 50 or the integrated terminal 101 may perform an operation for selecting an optimum path. The path selection operation may be very useful for a device including a map data.

Also, in the case that the ITS provides lighting state information of signal lights to a vehicle as one of the traffic information, the vehicle may find out how long time the vehicle should standby under a current signal light. In this case, a system of the vehicle may reduce a load on an engine or turn off the engine in the case that the vehicle should standby for several dozens of seconds to several minutes so that energy of the vehicle may be saved. Meanwhile, if the vehicle system or the integrated terminal 101 finds out when a green signal light of a currently passed point is turned off based on the lighting state information of the signal lights provided by the ITS, it may be determined whether to pass the signal light based on a current velocity of the vehicle and a distance to the signal light. Therefore, a driver may determine whether to stop or drive faster. The determination makes a drive more efficient and reduces a traffic jam at a crossroad.

The method of the present invention may be stored into a recording medium such as CD ROM, RAM, ROM, floppy disk, hard disk, and magneto-optical disk as a computer-readable program. Since this process is easily performed by those skilled in the art, detailed explanations are omitted.

According to the embodiments of the present invention, in the case of providing the supplementary information of the integrated terminal to another system, a new service is created. For instance, according to the current ITS, the traffic density collector is needed for each road; however, the traffic density collector can be eliminated or minimized in the case of providing the supplementary information of the integrated terminal own by a driver to the ITS. Therefore, the burden of installing equipment for collecting information is reduced, and various services for a drive currently unavailable can be provided.

According to the embodiments of the present invention, the information service can be more efficiently provided through interoperations of the integrated terminal and systems. Therefore, in the case that the mobile communication system is interoperated between the ITS and the integrated terminal, the information of a vehicle or movement can be transferred to the ITS or transport-related information acquired by the ITS can be transferred to the vehicle system.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for acquiring information from a mobile object, the method comprising:
providing information acquired from the mobile object to an integrated terminal;
providing needed information among information outputted from the integrated terminal to a communication system; and
providing the information outputted from the communication system to an information acquisition system interoperated with the integrated terminal and the communication system.

2. The method of claim 1, wherein the information acquisition system is an Intelligent Transport System (ITS) in the case that the mobile object is a vehicle.

3. The method of claim 2, wherein the needed information provided to the communication system comprises at least one of location information of the vehicle, speed information of the vehicle, velocity information of the vehicle, departure place information, and destination information.

4. The method of claim 2, wherein the communication system also transfers location information of the integrated terminal detected by a base station to the ITS when the communication system provides the information to the ITS.

5. The method of claim 2, wherein information of the vehicle provided through the integrated terminal comprises at least one of a vehicle ID with a car number, a kind of the vehicle, accident occurrence information related to a traffic accident or a vehicle breakdown, and air bag deployment information.

6. The method of claim 3, wherein the ITS checks whether a speed of a vehicle is rapidly decreased and a vehicle density is rapidly increased when a vehicle approaches a certain point and the speed of a vehicle is increased and the vehicle density is decreased after a vehicle passes the certain point using the location information and velocity information of a vehicle to detect an abrupt traffic jam.

7. A method for providing information to a mobile object, the method comprising:
providing information obtained by an information acquisition system to an interoperable communication system; and
providing information outputted from the communication system to the mobile object.

8. The method of claim 7, wherein the mobile object is an integrated terminal interoperated with the communication system in the case that the information acquisition system is an Intelligent Transport System (ITS).

9. The method of claim 8, wherein information of the integrated terminal is transferred to a vehicle.

10. The method of claim 9, wherein the vehicle calculates a standby time under traffic lights at a current location using traffic lights control information provided from the ITS to save energy of the vehicle.

11. A method for providing drive information to a driver, the method comprising:
transferring traffic lights control information of an Intelligent Transport System (ITS) to an integrated terminal through a communication system;
generating information which indicates whether it is possible to pass traffic lights by calculating a current speed of a vehicle and a distance between the vehicle and the traffic lights based on the traffic lights control information; and
providing the generated information to the driver.

12. An interoperation system, comprising:
a vehicle system configured to provide vehicle information and drive-related information being installed to a vehicle;
an integrated terminal configured to receive information outputted from the vehicle system;
a communication system configured to receive needed information among information outputted from the integrated terminal; and
an intelligent transport system configured to be interoperated with the integrated terminal and the communication system and receive information outputted from the communication system.

13. The interoperation system of claim 12, wherein the information outputted to the communication system is at least one of location information of the vehicle, speed information of the vehicle, velocity information of the vehicle, departure place information, and destination information.

14. The interoperation system of claim 13, wherein the information provided by the vehicle system comprises at least one of vehicle ID with a car number, a kind of the vehicle, accident occurrence information related to a traffic accident or a vehicle breakdown, and air bag deployment information.

15. The interoperation system of claim 14, wherein the intelligent transport system determines a traffic jam state in real time detecting a vehicle density at a crossroad and lengthens a lighting time of traffic lights on a road where the vehicle density is high in the case of controlling traffic lights using the location information and velocity information of each vehicle.
